(19) United States
(12) Patent Application Publication
(10) Pub. No.: US 2010/0257214 A1
(43) Pub. Date: Oct. 7, 2010

(54) MEDICAL RECORDS SYSTEM WITH DYNAMIC AVATAR GENERATOR AND AVATAR VIEWER

(76) Inventor: Luc Bessette, Montreal (CA)

Correspondence Address: RATNERPRESTIA, P.O. BOX 980, VALLEY FORGE, PA, 19482, US

(21) Appl. No.: 12/726,959

(22) Filed: Mar. 18, 2010

Related U.S. Application Data
(60) Provisional application No. 61/161,299, filed on Mar. 18, 2009.

(51) Int. Cl. G06F 17/30

(52) U.S. Cl. 707/812; 707/E17.009

(57) ABSTRACT

A medical records system, including a data processing apparatus including a CPU and a computer readable storage medium encoded with a program for execution by the CPU. The program processes medical information in connection with a subject to generate an avatar of the subject which reflects the medical status of the subject.

### CROSS REFERENCE TO RELATED APPLICATION

This application claims benefit of priority of U.S. Provisional Patent Application No. 61/161,299, filed Mar. 18, 2009, which is incorporated herein by reference.

### FIELD OF THE INVENTION

The invention relates to a system and components thereof for implementing medical records which store medical information in connection with a subject, such as a human being or an animal. The system can generate an avatar of the subject and dynamically update the avatar according to the medical condition of the subject.

### BRIEF DESCRIPTION OF THE DRAWINGS

A detailed description of examples of implementation of the present invention is provided hereinbelow with reference to the following drawings, in which:

FIG. 1 is a high level block diagram of a system for implementing medical records, according to a non-limiting example of implementation of the invention;

FIG. 2 is a high level flowchart illustrating the process for generating an avatar in connection with a subject and for updating the avatar;

FIG. 3 is a high level block diagram of a program executable by a computer to generate an avatar;

FIG. 4 is a more detailed block diagram of a module of the program illustrated at FIG. 3, for generating a personalized avatar;

FIG. 5 is a block diagram of a rules engine of the program module for generating a personalized avatar;

FIG. 6 is a more detailed block diagram of a module of the program illustrated at FIG. 3, for updating the avatar;

FIG. 7 is a block diagram of a rules engine of the program module for updating the avatar;

FIG. 8 is a block diagram of a module for updating the avatar on the basis of image based and non-image based medical conditions of the subject;

FIG. 9 is a flow chart of the process for updating the avatar on the basis of image data obtained from the subject;

FIG. 10 is a block diagram of an avatar viewer module;

FIG. 11 is a more detailed block diagram of the avatar viewer module shown in FIG. 10.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

For the purposes of the present specification, the expression “avatar” refers to a graphical representation of a subject which reflects the medical condition of the subject. The avatar can be stored as a set of data in a machine-readable storage medium and can be represented on any suitable display device, such a two-dimensional display device, a three-dimensional display device or any other suitable display device.

The avatar graphically depicts medical conditions of the subject. In one specific and non-limiting example, the avatar is a virtual representation of the human/animal body that is personalized according to the subject's traits or attributes and also adapted according to the medical condition of the subject. A physician or any other observer can navigate the virtual representation of the body to observe the internal/external structures of the body. The representation of the internal/external structures of the body can be static. Those structures can be manipulated in three dimensions or observed in cross-section by using an appropriate viewer. It is also possible to use animation techniques to simulate motion within the body or outside the body. For example, animation techniques can show a beating heart, simulate the flow of body fluids (e.g., blood) or other dynamic conditions. Motion outside the body may include, for instance, motion of limbs, such as arms, legs head, etc.

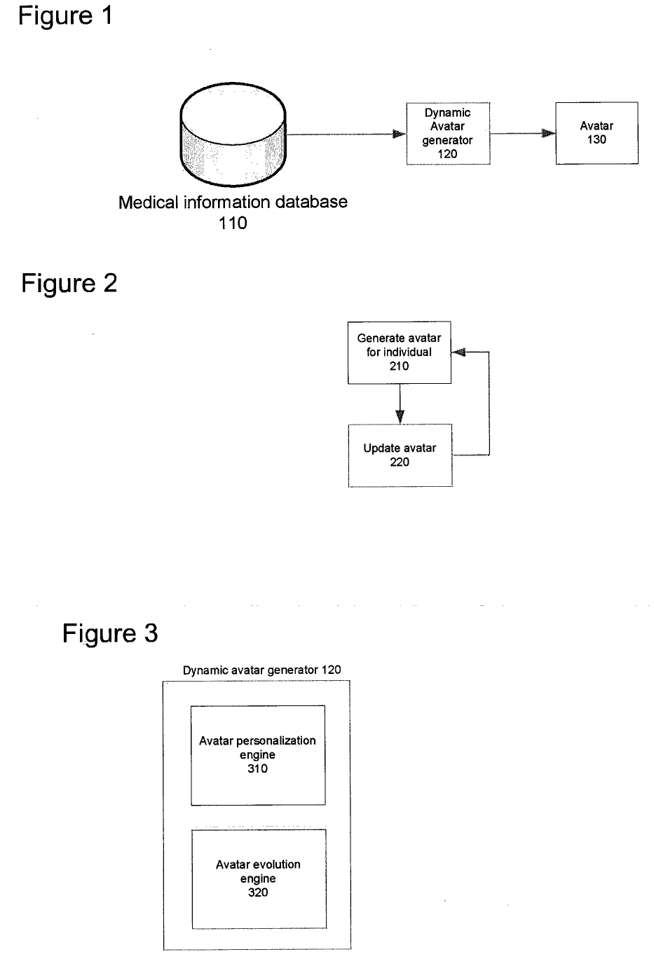

The components of a medical records system 10 are illustrated in FIG. 1. The system 10 has two main components, namely a medical information database 110 and a dynamic avatar generator 120. The medical information database 110 contains information of medical nature in connection with a subject, such as a human or an animal. Examples of the medical information within the database 110 can include:

1) Static information, which is characterized by certain information that is inherent to the individual and is therefore not expected to change. Examples of static information may include a person's name, gender, blood type, genetic information, eye color, distinguishing marks (e.g., scars, tattoos). Other types of related information that could be considered static information may include:

a person's family medical history (i.e., known conditions of their father or mother);

information that is changeable in the longer term, such as a person's current address, phone number(s), regular physician (if available), emergency contact details and/or known allergies.

Static information in the medical information database 110 would also include a universal or network-attributed identifier that would allow one record or file (and therefore a subject) to be distinguished from another. Use of such an identifier would allow the contents of a person's medical history to become accessible from the information database 110.

(2) Medical condition information of the subject, such as a list of the subject's current or past illnesses and/or test data associated with the current and past illnesses. The test data could include the test results performed on the subject such as blood tests; urine tests blood pressure tests, weight, measurements of body fat, surgeries, and results or imaging procedures such as x-rays, MRIs, CT scans and ultrasound tests, among others. The most recent results of those tests are stored in the file in addition to any previous tests performed on the subject.
(3) Pharmacological data associated with the subject, such as current and past drugs that have been prescribed.
(4) Lifestyle information associated with the subject, such as:
1. whether the subject is a smoker or non-smoker;
2. the level of the subject's Physical fitness (e.g., super fit, medium fit or not fit);
3. the amount of body fat (lean/average/obese), which may be determined through a measurement of the subject's BMI index;

It will appreciated that the above information may be organized within the medical information database 110 as individual records stored within the database (such as those stored within a table), or as records that are accessible to the database but are not otherwise stored within the database. Since the organization of information within databases are believed to be well known in the art, further details about the organization of the aforementioned information within the medical information database 110 need not be provided here. For additional information about medical record structures the reader may refer to the U.S. Pat. Nos. 6,775,670 and 6,263,330 the contents of which are hereby incorporated by reference.

In addition to the medical information database 110, the medical records system 10 includes the dynamic avatar generator 120, which is software implemented to generate an avatar. The dynamic avatar generator is a program code stored in a machine readable storage medium for execution by one or more central processing units (CPUs). The execution of the program code produces an avatar 130, which is data that provides a representation of the subject and illustrates its traits and/or medical conditions.

The medical records system 10 may be implemented on any suitable computing platform, which may be standalone or of a distributed nature.

The computing platform would normally include a CPU for executing the program and a machine-readable data storage for holding the various programs and the data on which the programs operate. The computing platform may be a standalone unit or of distributed nature, where different components reside at different physical locations. In this instance, the various components interoperate by communicating with one another over a data network. A specific example of this arrangement is a server-client architecture, where the various databases holding the medical information reside at a certain network node and clients, which are machines on which users interact with the medical records.

To allow a user to interact with the medical records system 10, the system 10 also implements a user interface that allows a user to access a particular medical record, modify a particular medical record and view and/or modify the avatar (depending on permission levels). In particular, the user interface provides the following functionality:
1. Create a medical record in connection with a subject
2. View an existing medical record in connection with a certain subject;
3. Modify an existing medical record in connection with a certain subject such as entering data regarding a medical test performed on the subject;
4. Delete a medical record.

For security purposes, access to the functions above may be determined on the basis of access levels, such that certain users of the system 10 can be allowed to create/modify/delete records while others are given only permissions to view the information in the record. Yet other users may be allowed to view only certain information associated with the record (such as static information), while other information associated with the subject (e.g., a subject's medical condition information) would be rendered inaccessible. In this way, the information associated with each subject within the system 10 generally, and the medical information database 110 in particular, can be protected.

The user interface allows a user to view the avatar 130 associated with the particular medical record. A viewer module, which is implemented in software, provides the user with the ability to interact with the avatar data to manipulate the data and generate the view that provides the information sought. The viewer module will be described later in greater detail.

FIG. 2 illustrates the general process that is implemented by the dynamic avatar generator 120 in order to create the avatar 130. The process includes two main steps. The first step is the generation of the avatar for a particular subject. At step 210, an avatar is generated for a subject using the dynamic avatar generator 120. In short, at this step, the program starts from a generic avatar and adapts this avatar to the subject. The output of step 210 is an avatar that is tailored to the subject and represents the subject in terms of human body structure.

The second step of the process 220 is that of avatar updating. At that step the avatar is altered over time to reflect the medical evolution of the subject such that the avatar continues to be an accurate representation of the body of the subject. This process will be described in greater detail below.

FIG. 3 is a more detailed block diagram of the dynamic avatar generator 120. The dynamic avatar generator 120 has two main modules, namely an avatar personalization engine 310 and an avatar evolution engine 320, which correspond to the two main steps of the process shown in FIG. 2.

The functionality of the avatar personalization engine 310 is discussed below with regards to the generation of a new avatar, which is associated with step 210. The functionality of the avatar evolution engine 320 will be discussed later in the context of updating the avatar, which occurs at step 220.

The avatar personalization engine 310 is used to customize the avatar 130 in certain ways so that it can represent its corresponding subject more realistically. The engine 310 can be used to personalize both an avatar's external appearance, as well as adjust its internal organ structure so that the avatar 130 is as faithful a representation of its corresponding subject as possible.

Use of the avatar personalization engine 310 allows the generic avatar 130 to be personalized in two (2) ways, namely an external personalization and an internal personalization. External personalization involves adjusting the appearance and structure of the avatar 130 so that it represents the appearance of its corresponding subject. To provide this control, the avatar personalization engine 310 provides tools to the user via the user interface to control all aspects of the avatar's 130 external appearance.

Certain aspects of an avatar's external personalization may be manually configured, such setting a particular eye color or hair texture (e.g., curly or straight) for the avatar 130. Other aspects of external personalization for the avatar 130 may be automatically configured by the personalization engine 310 based on a user's choices, such as those based on a chosen sex (i.e., whether the subject is male or female). For example, indicating that a subject is male allows the avatar personalization engine 310 to include male reproductive organs within the appearance of the avatar 130. Advantageously, such indications allow the personalization engine 310 to pre-configure a number of aspects of an avatar's appearance simultaneously that may save a user time and effort.

Although the use of indications (such as indicating the sex of the subject) in order to pre-configure a number of aspects of the avatar's appearance can be helpful, further personalizing the avatar so that it resembles the subject may require considerable time. To reduce the amount of time required, the avatar personalization engine 310 may provide the ability to ‘import’ a photograph of the corresponding subject (which may be in two- or three-dimensions) so that this photograph may be used to further personalize the avatar.

For example, the avatar personalization engine 310 could apply a frontal photograph of the face of the subject to the “face” of the avatar 130 such that the avatar's face resembles that of its subject. This could be done either by simply wrapping the photograph as a texture to the default face of the avatar, or by extracting biometric information from the photograph such that biometric features in the face of the avatar 130 would be adjusted in a similar fashion.

Similarly, the avatar personalization engine 310 could use a two- or three-dimensional photograph of the subject's body in order to apply similar body measurements to the appendages of the avatar 130. For example, the engine 310 could extract biometric information about the relative length of the arms and/or legs to the torso of the subject in order that the same relative lengths would be applied to the avatar 130.

The result of the external personalization process is the production of an instance of the avatar 130 whose appearance resembles that of its corresponding subject. While certain means for such personalization have been described above, it will be appreciated that other ways of personalizing the external appearance of an avatar exist and would fall within the scope of the invention.

Similarly, the avatar personalization engine 310 also allows the internal organs and systems (e.g., veins and arteries in the circulatory systems) comprised in the avatar 130 to be customized. By default, every avatar 130 is created with a generic set of individual organs and systems for their chosen sex, which are supposed to correspond to the subject's set of internal organs and systems. This generic set of organs and systems are also controlled by a set of rules and conditions that define how these organs are supposed to work by default.

Because no subject's organs or systems will be exactly same as this ‘generic’ set, the avatar personalization engine 310 can be used to more closely match the organs and systems of the avatar 130 to those of its corresponding subject.

For example, the default ‘heart rate’ for an avatar representing a 40-year old male may be defined as 80 beats per minute, but a man's default heart rate is actually recorded at beats/minute. To accommodate this difference, the personalization engine 310 sets the heart rate of the man's avatar to 95 beats/minute as well. Those skilled in the art will appreciate that other adjustments to the internal physiology of the avatar 130 may be made in a similar manner.

Use of the avatar personalization engine 310 to adjust or customize the avatar 130 may be initiated in several ways, including:

manual adjustment, which may be based on a person's input, namely the person opening the medical record or creating the personalized avatar. The manual adjustment may include for different internal body structures a list of possible choices and the person simply chooses the option that suits the subject best;

automatic adjustment, which may be based on existing information in medical records and/or photos or other data that represents the subject; and/or

biometric adjustment, which may be based on a scan of the person's body such as from a CT scan X-rays, MRIs or others.

It is worth noting that automatic and/or biometric adjustments of the avatar 130 may be implemented by a separate image processing software module that is initiated by the avatar personalization engine 310. Upon such initiation, the software module may process the image data (which may be two-dimensional, such as in X-ray images or three-dimensional, such as in CT scans) in order to detect certain salient features of the scanned internal structures in the image and then apply those features to the avatar 130.

For example, assume that the avatar personalization engine 310 receives an X-ray image of a bone and surrounding tissue for a subject. The engine 310 may submit this image to the image processing software module in order to extract measurements so that a three-dimensional model of the bone and surrounding tissue (e.g., muscles) can be replicated in the avatar. The software module may process the image in order to identify certain features of the bone, such as its dimensions, that may be identified by observing and identifying differences in the gray-scale gradient between the bone and surrounding tissue that exceed a certain known value. By identifying the dimensions of the bone from the two-dimensional X-ray image, a three-dimensional model of the corresponding bone can be created and applied to the avatar 130 for the subject. Similar processes may be used by the image processing software module to observe and identify different tissues (e.g., muscle tissue versus tissue for veins or arteries) within the surrounding tissue in order that three-dimensional models of such tissues can be generated.

Although the above example used a two-dimensional X-ray as the basis for generating a three-dimensional model, it will be appreciated that the image processing software module used by the avatar personalization engine 310 may also process three-dimensional data (such as that supplied by a CT scan) in a similar manner.

Note that the personalization step 210, as shown and described above, may be a one-time processing operation or a continuous process that refines the avatar 130 over time. For example, the initial medical information available on the subject may be limited and may not include a complete set of medical data to personalize every structure of the body. Accordingly, in such instances, the avatar 130 may only be partially personalized by the engine 310, and body features and structures for which no medical information is available from the subject would not be modified from their generic or default version. However, as new medical information becomes available (such as an X-ray image of a bone that was never imaged before), that information can be used by the avatar personalization engine 310 to further personalize the avatar 130 by altering the generic version of the bone to acquire the features observed in the X-ray.

It will also be appreciated that the avatar personalization engine 310 has the ability to apply certain exceptions to the appearance and/or internal physiology of the avatar 130. For example, assume that a 20-year old male soldier has lost his right leg below the knee. To make his avatar as representative as possible, the engine 310 may be used to remove his right leg and foot from the avatar's external appearance. In certain cases, the avatar may be provided with a prosthetic leg and foot that correspond to the prosthetics actually used by the male soldier.

In addition, the internal physiology of the avatar's right leg may be further adjusted by the avatar personalization engine 310 such that the bones, veins, arteries and nerve endings terminate at the same point as they do in the soldier's real leg. Such customization to the avatar may be initiated by and/or based on X-ray or CT scans of the area in question.

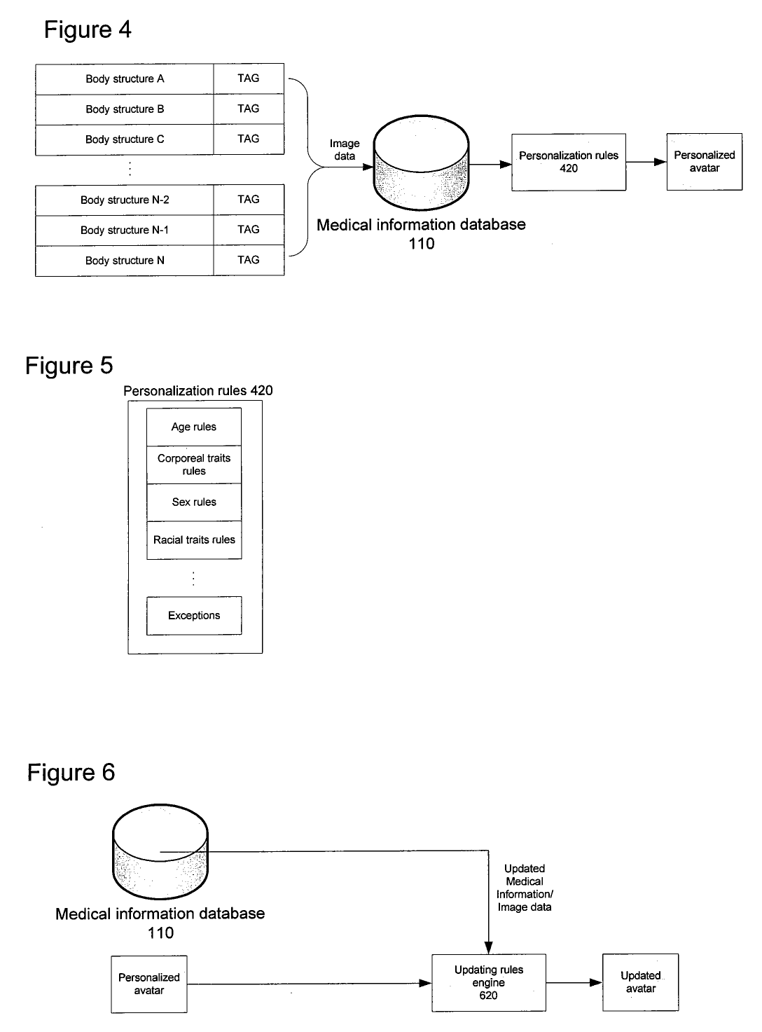

FIG. 4 is a yet more detailed block diagram of the avatar personalization engine 310. The avatar personalization engine 310 operates on the basis of a set of personalization rules that condition a set of input data to create a personalized avatar. The input conditions can be represented by a Human Anatomy and Composition Representation database 410 (referred to as the HACR database hereafter).

The contents of the HACR database 410 include the input conditions that anatomically define the external appearance and/or internal physiology of each generated instance of the avatar 130. In this respect, the HACR database 410 may be seen as providing a similar function as that typically provided by human or animal DNA, but at a much higher level, in that the database 410 provides a default template for the composition and construction of each instance of the avatar 130.

The contents of the HACR database 410 are structured and organized according to a Body Markup Language (BMR), which is a language that expresses body (human or animal) structures. A BML functions by associating a certain structure of the body with a tag. Each tag defines the characteristics of the body structure, such as how the body structure would appear when it is viewed and how it relates to other body structures. Therefore, a BML representation of the body requires breaking down the body into individual structures and then associating each structure to a tag.

Examples of individual structures that would likely be found in the BML include:
1. Skeletal structure—where each bone of the skeleton (for the sake of the description, assume a human skeleton with 206 bones) can be a discrete structure;
2. Respiratory system—where each component of the respiratory system (e.g., airways, lungs and respiratory muscles) can be a discrete structure;
3. Circulatory system—where each component of the circulatory system (e.g., the blood distribution network; (2) blood pumping system (heart) and lymph distribution network) is a discrete structure;
4. Muscular system—where each individual muscle (e.g., bicep and tricep in an arm) is a discrete structure;
5. Nervous system—where each component of the central nervous system network and the peripheral nervous system network are discrete structures (e.g., spinal cord, sciatic nerve);
6. Digestive system—where each component of the digestive system (e.g., mouth, teeth, esophagus, stomach, small intestine and large intestine) is a discrete structure;
7. Urinary system—where each component of the urinary system (e.g., kidneys, bladder, urethra and sphincter muscles) is a discrete structure;
8. Reproductive system—where each component of the reproductive system (e.g., the genitalia (distinguished on the basis of gender), gamete producing gonads for males and ovaries for females) is a discrete structure.
   Note that the above are examples only.

It is worth noting that the structures (and their associated tags) described above define an implicit anatomical and physiological taxonomy of an animal or human body whose granularity in terms of individual structures may vary depending on the application. For example, while single cells could be considered as individual structures within the taxonomy of the tagging language, given the huge number of cells in a body, exceedingly large computational resources would be required to express the body structure at such a fine level of detail. Conversely at the other end of the taxonomy, body structures can be simplified to individual systems, such as where the entire urinary system or the respiratory system can be considered as a single discrete structure.

Each individual structure can be represented as image data stored in a machine readable storage medium. The image data can be in any suitable format without departing from the spirit of the invention.

The degree of image detail for each individual structure can vary depending on the intended application. For example, the image data for a structure may be as simple as including a two-dimensional image of the structure, such as an image extracted from an X-ray scan. In another example, the image data can include a three-dimensional image of the structure, such that during visualization the image can be manipulated so that it can be seen from different perspectives.

Another possibility is to provide a structure that can be represented by a three-dimensional modeling program on the basis of a three-dimensional mesh. The mesh can be resized, stretched or otherwise modified to change the shape of the basic organ. The three-dimensional modeler also can include a texture-mapping feature that can apply textures onto the mesh. The three-dimensional modeler can be used to generate a three dimensional image of the outside of the structure but also can be used to generate a complete three dimensional representation of the entire structure, showing its outside surface and also its internal features as well. In the case of a human heart, for example, this form of representation could be used to show the internal structure of the human heart, therefore allowing a user to see the outside of the heart, manipulate the heart to see it from different angles, take virtual ‘slices’ (cross-sections) of the heart to expose the inside structure at a certain point or ‘fly through’ the heart in order to review its external or internal structure.

Yet another possibility is to provide image data that actually contains several different representations of the organ, which may be two-dimensional, three-dimensional or could be represented by a three-dimensional modeling program. In this instance, the various representations of the organ could be individually analyzed and then combined to form a single organ based on observed overlaps between the different representations or prior knowledge of the structure of the organ.

Each structure is further associated with a tag that contains instructions about the manner in which the image data behaves. Examples of such instructions include:
1. Image modifiers that alter the image data to produce altered image data. The alterations can be dimensional alternations where the dimensions of the organ are changed and/or textural alterations where the texture of the external surface of the structure is changed. The alternations can also add or subtract components from the structure. These image modifiers can be used alone or in combination to alter the image data such as to adapt the image data to a particular subject, in other words adapt the image of the structure such that it matches the corresponding structure in the body of the subject.
2. Relationship with other structures. The relationship instructions can include structural relationships allowing locating the structure properly in relation to an adjacent structure in the body. For example, when the structure is a bone, the tag may contain location instructions to specify where that bone is located with relation to other bones. In this fashion, the entire set of bones can be displayed to a user where each bone is correctly located. The relationship can also include functional relationships definitions, allowing specifying the functional group to which the structure belongs. There may be instances where the three-dimensional position of one structure with relation to another is unimportant. Rather, it is important to functionally relate a group of structures. One example is the digestive system. A functional connection exits between the mouth and the intestine as they are both components of the digestive system while they are only loosely related in terms of physical position.
3. Kinetic definitions. These are instructions or parameters that define motion of structures. A kinetic definition allows animating or showing movement of the body. The motion can be as simple as the movement of a limb (e.g., motion at the elbow) or as complex as animation of a beating heart or blood flowing through veins or arteries. In the case of a simple motion, the kinetic definition specifies the mechanical parameters to define the movement, such as the structures involved, the location of the pivot point and the allowed range of motion. When more complex animation is necessary, the kinetic parameters may define fluid dynamic models to simulate blood flows through veins and arteries.

In order to personalize the avatar 130, the information within the HACR database 410 may be subjected one or more rules in a set of personalization rules 420. The rules 420 define certain conditions or settings that adjust the appearance or internal physiology of the avatar 130 in concordance with that observed in the corresponding subject.

In order to personalize the avatar 130, the information within the HACR database 410 may be subjected one or more rules in a set of personalization rules 420. The rules 420 determine how the generic avatar will be altered to match the subject. The personalization rules include logic that alters the image data associated with the respective body structures. That logic is embedded in the tags of the respective structures such that the behavior of the image data corresponding to the structures changes as desired.

The image alterations during a personalization process of the generic avatar are designed to perform the following, including among others, aging, changes to corporeal traits, changes based on gender or race, as well as possible exceptions. Further information about these alterations defined by the personalization rules are provided below.

Aging (or age adjustment) rules refer to adjustment rules that are intended to adjust the visual appearance of the set of structures comprising the avatar 130 so that they match the age of the subject.

In one possible form of implementation, a set of age adjustment rules exist, where different aging rules apply to different structures, as different structures are affected in a different way as a result of aging. Each age adjustment rule models the effect of aging on a structure and in particular on how a structure appears.

The model, which as indicated earlier, may be specific to an individual structure or may affect a set of structures, can be based on empirical observation on the effect of aging on body structures. For example, in the case of human bones, aging can affect the bone dimensions and its density. As a person ages, his or her bones are likely to shrink slightly and also become more porous.

To model this effect, an aging rule will typically include logic that changes the image data such that the image of the bone is resized as a function of age. As a result, the older the subject, the smaller his or her bones will appear. The degree of re-sizing can be derived from medical knowledge and observation and would generally be known to those skilled in the art.

Because a similar relationship is known to exist between bone density and age, another age adjustment rule for human bones may be used to depict changes to bone porosity with age. In this case, pores are created in the image (either at random positions or at predetermined positions), where the number of pores and their size is dependent on the age of the subject. As a result, the older the subject, the higher the number of pores and the larger their size will be.

Another example of an aging rule may relate to the pigmentation, color and texture of the skin. The age adjustment rule associated with these body structures define a texture and color model that is age-dependent. For example, the texture and color gradations can be based on empirical observations that mimic how the skin ages. As the subject gets older, the texture and color models will render the image of these structures in a way that will realistically mimic the skin of an older person on the avatar 130. For instance, the model may control the rendering of the surface of the skin, such that the skin looks rougher and may have small dark dots randomly distributed.

Yet another example of an age adjustment rule could be a rule that affects the appearance of the prostate gland. As is generally well known, the size of the prostate often becomes enlarged with age. The age adjustment rule would therefore be designed to alter the size (and possibly shape) of the prostate such that it becomes larger with age.

Another possible example of an aging rule may be one associated with gums. It is well known that as a person ages, his or her gums recede. Accordingly, the model implemented by the age adjustment rule would be designed to alter the image data of the gums such that the gums appear as receding, where the amount of receding is dependent on age.

In addition to changing the way the image of a structure appears to an observer, age adjustment rules can also be provided that alter certain kinetic functions which are known to be age-dependent. For instance, age typically affects the range of motion at a joint, such as the knee or elbow. To model these effects, an aging rule may be implemented that when the avatar 130 displays movement at those joints, the motion is restricted to a range that is age dependent. As a result, the avatars of higher aged subject would have a lower range of motion for the affected joints and related structures.

It will be appreciated that simulation of other motions can be conditioned in a similar way. For instance the general heart beat rate for the avatar 130 may be lowered as age increases to reflect known medical knowledge about the relationship between a person's heart rate and his or her age.

In addition to the age adjustment rules discussed above, the personalization rules engine may also include the following:
Corporeal Trait rules: rules that define changes to the avatar 130 based on certain corporeal traits, such as the length of arms/legs relative to the torso;
Gender rules: rules that define changes to the avatar 130 based on the selected genders, such as the relative location of reproductive organs and/or breast muscles/mammary glands;
Racial Trait rules: rules that define changes to the avatar 130 based on a selected race (where applicable or allowed), such as an adjustment of the epicanthic fold of the eyelid for those of Asian descent; and
Exceptions: exceptions to one or more of the above rules, which is likely based on observation or existing medical records, such as a missing arm or leg.

Those skilled in the art will appreciate that the above list of categories for the set of personalization rules 420 is not exclusive and that other categories and/or rules may fall within the scope of the invention.

FIG. 6 is a yet more detailed block diagram of the avatar evolution engine 320. The avatar evolution engine 320 operates on the basis of a set of ‘evolution’ rules that condition a set of input data to update an avatar from a prior state to a new state. The starting point of the updating process is the personalized avatar. The personalized avatar therefore is altered progressively by the updating engine such as the avatar continues to represent the subject as the body of the subject evolves over time and changes due to aging and medical conditions. Generally, the changes to the avatar made by the updating rules engine can include progressive changes such as those due to aging and discrete changes resulting from specific medical conditions encountered.

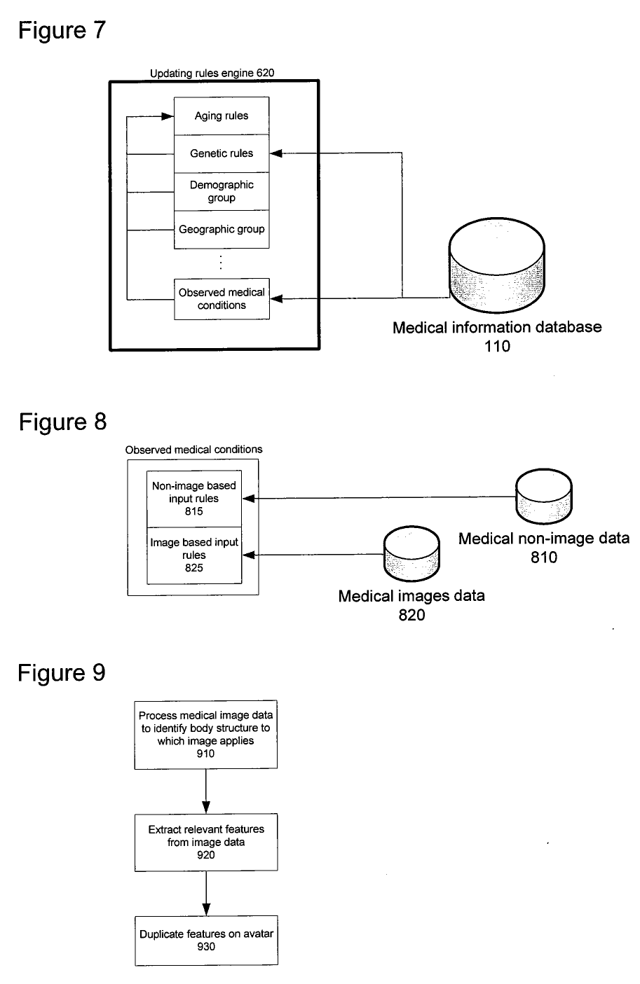

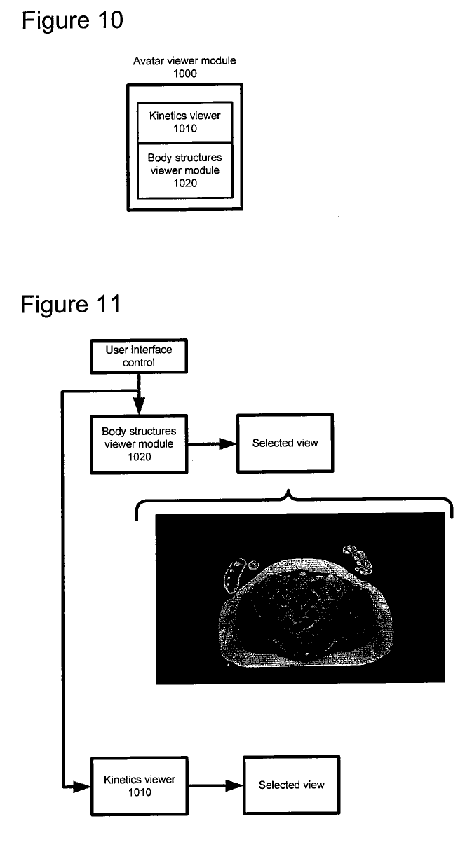

The set of ‘evolution’ rules that condition the input data in order to update an avatar from a prior state to a new state are represented in FIG. 6 by an updating rules engine 620. FIG. 7 shows various categories of rules that may be included within the set of evolution rules represented by the engine 620, which could include among others:
Aging rules: rules that define changes to the avatar 130 between states as the body of the corresponding subject ages, such as changes to the skin texture of a person as they age. These rules can be the same or similar to the aging rules discussed earlier in connection with the personalization rules;
Genetic rules: rules that model progressive changes to the different structures of the avatar 130 between states according to the genetic profile and makeup of the corresponding subject;
Demographic group rules: rules that model progressive changes to the avatar between states according to the general demographic group to which the corresponding subject belongs, such as changes known to afflict 40-45 year old white male smokers who consume between one and two packs of cigarettes per day;
Geographic group rules: rules that model progressive changes to the avatar between states according to the general geographic locale to which the corresponding subject belongs, such as changes due to living in a urban environment where exposure to fine particulates and other pollutants is higher than in a rural environment; and/or
Observed medical condition rules: rules that are generated from observed medical conditions, such as medical conditions observed from X-rays or blood tests (e.g., blood clots in the case of stroke) and generally medical observations about the medical condition of the subject.

It is worth noting that one or more of the rules (and in particular, the observed medical condition rules) in the updating rules engine 620 described above may originate from the medical information database 110. For example, the genetic rules may originate from the genetic profile of the corresponding subject, which may be stored in the database 110.

In certain cases, the aging rules in the updating rules engine 620 may be updated or altered based on contributions from the other rule categories. For example, the geographic and/or demographic group categories may cause an adjustment in the aging rules that causes the avatar 130 to age faster or slower than would otherwise be expected. For example, the aging rules for a Chinese male laborer who lives in or around central Shanghai, China and smokes at least two (2) packs of cigarettes a day would likely cause this subject's avatar to age more quickly than otherwise.

In contrast, the identification of certain genetic conditions in the genetic profile of a subject that confer improved resistance to certain diseases that are more common to a particular demographic group (e.g., resistance to heart disease in people 50 and above) that may be expressed in the genetic rules may cause the avatar 130 to age more slowly than would otherwise be expected.

The various rules within the updating rule engine 620 only govern the evolution of the avatar 130 between two states separated by time, namely a first, earlier state and a second, later state. It will be appreciated that such changes may or may not relate to the actual physiological evolution of the avatar's corresponding subject. In cases where the evolved state of the avatar 130 differs from that of its corresponding subject, the avatar 130 may be further updated based on observed medical conditions.

FIG. 8 illustrates a non-limiting method by which the updating rule engine 620 may update the avatar 130 between a first prior state and a second, more current state based on observed medical conditions. This figure includes two (2) sets of data, namely a medical non-image dataset 810 and a medical image dataset 820. Although the datasets 810 and 820 are presented here as separate entities, this is done for the sake of illustration. In reality, both of these datasets are quite likely to reside together in the medical information database 110.

The contents of the medical non-image dataset 810 typically contain medical information for the subject that is non-visual in nature, such as numeric test results, observation notes by medical personnel and/or biopsy reports, among others. Moreover, contents of this dataset may be linked to certain aspects of the HACR database 410, such as tagged content within the structures component 412 and/or internal kinetics component 414. For example, a test showing the blood pressure and flow through specific arteries in the cardiovascular system may be used to model blood flow in the avatar 130.

In contrast, the contents of the medical image dataset 820 include medical information that is visual in nature, such as X-ray images, photographs taken from a biopsy and/or CT-scan related data and ultrasound observations among others. Furthermore, contents of this dataset may be linked to or associated with the HACR database 410 in order to provide the images used for tagged structures within the structures component 412. For example, an X-ray of a leg bone and surrounding tissue may be associated with the tagged structure that defines how the leg bone and surrounding tissue in the avatar 130 is represented.

The avatar evolution engine 320 may monitor the contents of the datasets 810 and 820 in order that it can become aware of any new information that is added to these datasets from observation of the subject. Alternatively, the engine 320 may be advised of the addition of new data to the datasets 810 and 820 only at the time when the avatar 130 is to be updated.

Once the avatar evolution engine 320 becomes aware of new information in the datasets 810 and 820, it can use this information to update the observed medical condition rules components of the updating rules engine 620 in order to update the avatar 130 in a similar fashion.

In particular, new information within the medical non-image dataset 810 could be used to update a set of non-image based updating rules 815 that may be included within the observed medical condition rules category in the updating rules engine 620. Similarly, new information within the medical image dataset 820 could be used to update a set of image-based updating rules 825, which may also be included within the observed medical condition rules category in the updating rules engine 620.

For example, assume that a subject suffers a fall and that their brain is subjected to a CT scan to ensure that they are not suffering from a condition, such as a concussion or brain edema. The data generated by the CT scan of the subject's brain is stored within the medical information database 110 and becomes part of the medical image dataset 820 as a result.

The addition of this data to the dataset 820 may trigger the avatar evolution engine 320 to review and revise the updating rules engine 620 based on this new information. In particular, the engine 620 may use this data to update the observed medical condition rules category for the brain to update the previous image associated with the tagged brain entry in the structures component 410 (which would likely have been taken before the fall) with a new image updated to take into account the information contained in the CT scan data. Because the avatar evolution engine 320 now has two separate brain images from the subject, it can evaluate changes between the images in order to update the brain represented in the avatar 130 in the same way. This can be done by updating the observed medical condition category of the updating rules engine 620 to account for the new image, which may involve adjusting the image modifier information for the tag associated with the brain structure.

Although the above example used new image data within the medical image dataset 820 as the trigger for the update of the updating rules engine 620 by the avatar evolution engine 320, those skilled in the art will understand that a similar process could be used to update the non-image updating rules 815 based on information added to the medical non-image dataset 810.

FIG. 9 shows a flowchart that illustrates a non-limiting process by which information in the previously mentioned medical image dataset 820 (and/or the medical information database 110 as a whole) could be used to update the avatar 130.

At step 910, image data is processed to identify the particular structure (i.e., body part or organ of the avatar) to which the image applies. This data may be processed by the avatar evolution engine 320, by the updating rules engine 620 or by an image processing software module that is likely similar (if not identical) to discussed in the context of avatar personalization.

In certain cases, the structure or body part to which the image applies may be included within the image data. For example, an image taken of a femur bone may include metadata (which may be based on BML) that may indicate the image was of a left femur bone. Among other image-related information that might be provided within the image data may include the angle at which the image was taken, the device used to generate the image and/or an indication as to why the image was generated (e.g., as part of a standard checkup or as a result of certain trauma).

If such information is included within the image data, the process may proceed to the next step immediately. However, if this information is missing from or is not included with the image data, it may be extracted at this point by analyzing the medical image and comparing any features identified within it against known body structures and/or structures within the subject's body in particular.

For example, if a bone is identified within the image (such as by comparing adjacent gray-level gradient values), the size and shape of the bone may be compared to those found in existing images and/or models to see which of these produce the closest match. Returning briefly to the example of the femur X-ray mentioned above, if the image data for the X-ray did not include information defining the imaged bone as a femur, the identified bone may be compared against bones within the avatar 130 and/or medical image dataset 820, and more specifically, images that contain bones with a similar size, shape and/or orientation.

Since it is believed that knowledge of image processing and pattern matching techniques to achieve this result are known in the art, a further description of how this matching occurs will not be provided here. However, it is worth noting that the image processing and/or pattern matching may be performed against bones associated with the avatar 130 of the subject, against bones associated with the medical image dataset 820 or against bones known to be in images stored within the medical information database 110. This can increase the likelihood that a bone that is captured within an image will be matched correctly to its corresponding structure.

At step 920, relevant features are extracted from the image data. During this step, the image is processed to identify relevant features in the structure, which may include among others:
breaks or separations in the structure, such as from a broken bone;
changes in the dimensions, shape and/or density, such as those due to age;
unexpected growths or abscesses that might indicate disease, such as cancerous growths or tumours;

The process by which relevant features may be identified may include comparing the structure within in the current image with an image of the structure taken at a prior state, which may be stored within the medical image dataset 820. For example, an X-ray image of a subject's femur may be compared against earlier X-ray images of the same bone to identify any changes that have taken place.

It is worth noting that although steps 910 and 920 in FIG. 9 are shown in sequential order, the processing of the image that occurs in these steps may also be performed more or less simultaneously. Therefore, while the image is being processed to identify its corresponding structure (step 910), it may also be processed simultaneously to identify relevant features (step 920).

The result of the previous step was the identification of relevant features for the structure based on image data from the subject. In order to ensure the avatar 130 reflects the state of its corresponding subject, the avatar must be updated in the same way.

At step 930, the avatar 130 is updated to include the same relevant features as were identified during the previous step. This update to the avatar 130 is typically done by the avatar evolution engine 320 via the updating rules engine 620. More specifically, the update may be performed by the engine 320 using the updated non-image based input rules 815 and image-based input rules 825 of the observed medical conditions rule category residing within the engine 620.

Upon the completion of step 930, the avatar 130 will have been updated to reflect the most current medical condition of its corresponding subject. This process prepares the avatar 130 for viewing by medical personnel in order to diagnose and/or treat medical conditions affecting the subject.

FIG. 11 is a block diagram of an image viewer that can used for viewing the updated avatar in its entirety of components thereof. Generally, the image viewer is associated with the user interface of the medical record and a user can invoke the viewer from the user interface control. The viewer includes a body structures module 1020 that allows the user to select the particular structure or set of structures for display. For instance, the user can select a single structure to be shown, such as a bone or an organ, say the heart. The viewer can provide navigational tools allowing the user to rotate the image such that it can be seen from different perspectives, create slices to see the inside of the structure, among others. In the specific example shown, a slice through the entire body of the avatar is illustrated.

In addition to showing individual structures, the viewer allows the user to display a series of structures that are related to one another, either by virtue of physical relation or functional relation.

The viewer module also has a kinetics viewer that can show animation of selected structures. For instance the kinetics viewer can animate a joint and depict how the various bones move, simulate the beating of the heart, simulate the blood flow through a certain organ, etc.

Although various embodiments have been illustrated, this was for the purpose of describing, but not limiting, the invention. Various modifications will become apparent to those skilled in the art and are within the scope of this invention, which is defined more particularly by the attached claims.

1. A medical records system, comprising:
a. a data processing apparatus including a CPU and a computer readable storage medium encoded with a program for execution by the CPU, the program processing medical information in connection with a subject to generate an avatar of the subject which conveys the medical information;
b. the data processing apparatus having an output for releasing data representative of the avatar.
